(19) United States
(12) Patent Application Publication
(10) Pub. No.: US 2004/0085353 A1
(43) Pub. Date: May 6, 2004

(54) Information processing apparatus and display control method

(75) Inventors: Tomoyuki Kawakami, Hachioji-shi (JP); Kunio Ueda, Ome-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/694,940

(22) Filed: Oct. 29, 2003

(30) Foreign Application Priority Data
Oct. 30, 2002 (JP) 2002-315909

(51) Int. Cl. G09G 5/00

(52) U.S. Cl. 345/747

(57) ABSTRACT

An information processing apparatus includes a display device, setting processing section, and a control section. The setting processing section is capable of setting information related to a visual field angle of an object on a display area of the display device. The control section controls the visual field angle of the object on the display area in accordance with the information set by the setting processing section.

### CROSS-REFERENCE TO RELATED APPLICATIONS

This application is based upon and claims the benefit of priority from the prior Japanese Patent Application No. 2002-315909, filed Oct. 30, 2002, the entire contents of which are incorporated herein by reference.

### BACKGROUND OF THE INVENTION

1. Field of the Invention

The present invention relates to an information processing apparatus having a display device in which a visual field angle is controllable, and a display control method applied to the information processing apparatus.

2. Description of the Related Art

A technique of varying a visual field angle of a display device in an information processing apparatus is disclosed in Jpn. Pat. Appln. KOKAI Publication Nos. 10-240186, 2001-344050 and 2001-264768. Additionally, the technique is also disclosed in http://www.mmm.co.jp/cf/pf_crt.html. These documents and the like teach fixedly determining a visual field angle of a whole display area or a part of the display area.

In these techniques, however, usability or convenience for user is not fully considered, so that a user cannot arbitrarily set visual field angles of objects (such as a specified application program, specified area, etc.) on a display area.

### BRIEF SUMMARY OF THE INVENTION

Embodiments of the present invention may provide an information processing apparatus in which a user can arbitrarily set visual field angles of objects on a display area, and a display control method thereof.

According to one aspect of the present invention, there is provided an information processing apparatus, comprising a display device; a setting processing section capable of setting information related to a visual field angle of an object on a display area of the display device; and a control section configured to control the visual field angle of the object on the display area in accordance with the information set by the setting processing section.

According to another aspect of the present invention, there is provided a display control method applied to an information processing apparatus having a display device, the method comprising enabling a setting of information related to a visual field angle of an object on a display area of the display device; and controlling the visual field angle of the object on the display area in accordance with the information set in the setting.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of an information processing apparatus according to a first embodiment of the present invention;

FIG. 2 is a diagram showing a configuration of a visual-field-angle setting table according to the first embodiment;

FIGS. 3A, 3B, and 3C are diagrams showing configurations of each type of visual-field-angle setting screen according to the first embodiment;

FIG. 4 is a flowchart showing a first processing procedure according to the first embodiment;

FIG. 5 is a flowchart showing a second processing procedure according to the first embodiment;

FIG. 6 is a flowchart showing a third processing procedure according to the first embodiment;

FIG. 7 is a flowchart showing a fourth processing procedure according to the first embodiment;

FIG. 8 is a flowchart showing a first processing procedure according to a second embodiment of the present invention;

FIG. 9 is a flowchart showing a second processing procedure according to the second embodiment;

FIG. 10 is a block diagram showing a configuration of an information processing apparatus according to a third embodiment of the present invention;

FIG. 11 is a diagram showing a configuration of a visual-field-angle setting screen according to the third embodiment;

FIG. 12 is a diagram showing a configuration of an application table according to the third embodiment;

FIG. 13 is a flowchart showing a procedure of an automatic visual-field-angle change process according to the third embodiment; and

FIG. 14 is a block diagram showing a major part of a configuration of an information processing apparatus according to a fourth embodiment of the present invention.

### DETAILED DESCRIPTION OF THE INVENTION

Embodiments of the present invention will be described hereinafter with reference to the drawings.

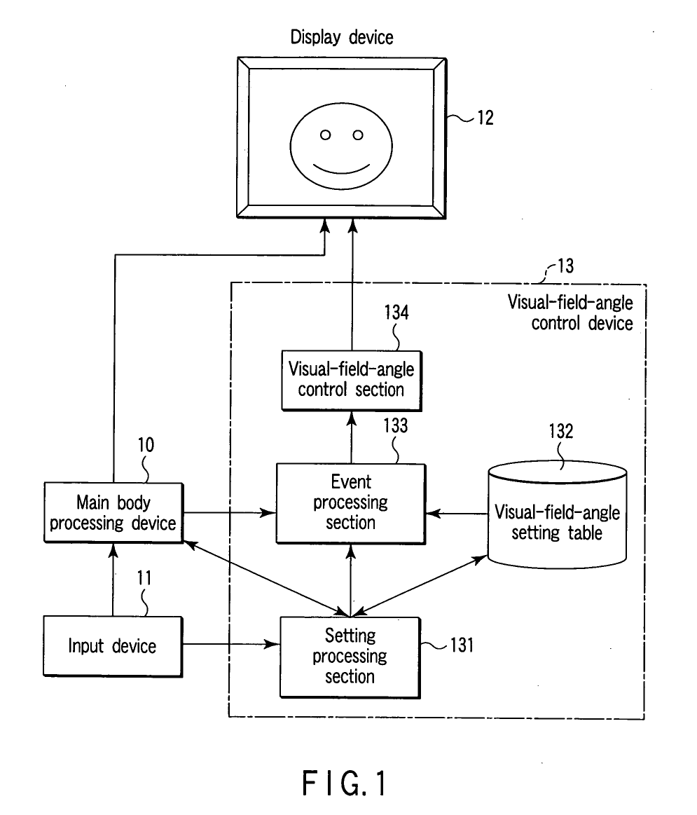

FIG. 1 is a block diagram showing a configuration of an information processing apparatus according to a first embodiment of the present invention.

The information processing apparatus in the first embodiment of the present invention includes a main body processing device 10, input device 11, display device 12, and visual-field-angle control device 13.

The visual-field-angle control device 13 includes a setting processing section 131, visual-field-angle setting table 132, event processing section 133, and visual-field-angle control section 134.

The main body processing device 10 controls whole operations of the system. For example, the main body processing device 10 executes processing of commands issued with an input operation of the input device 11, and reflects the processing on a display area of the display device 12. Furthermore, the main body processing device 10 notifies various event information including a type of a window, start of application, and the like associated with a system operation to the event processing section 133.

The input device 11 includes a keyboard, a pointing device and the like, and notifies the main body processing device 10 of commands in response to input operations. For example, a user can use the input device 11 to execute various setting operations on a visual-field-angle setting screen (described later) via a GUI.

The display device 12 includes a liquid crystal display, in which a visual field angle of each window is controlled by the visual-field-angle control section 134. In the display device 12, various visual-field-angle setting screens for setting the visual field angle can be displayed via a GUI in accordance with operations by a user.

The setting processing section 131 variably sets a visual field angle of an object on a display area of the display device 12. Specifically, the setting processing section 131 stores visual-field-angle information and the like in accordance with designations by a user on various visual-field-angle setting screens via a GUI, in the visual-field-angle setting table 132, and notifies the event processing section 133 of the fact as an event.

The visual-field-angle setting table 132 contains visual-field-angle information and the like, which have been set by the setting processing section 131, in a predetermined link structure. The visual-field-angle information includes, e.g., rectangular region as an object of the visual-field-angle control, upper/lower/left/right angle, and a viewing direction.

The event processing section 133 reads the corresponding visual-field-angle information stored on the visual-field-angle setting table 132 in response to an event and sends the read information as visual-field-angle control instruction information to the visual-field-angle control section 134. More specifically, the event processing section 133 receives various events from the main body processing device 10 or visual-field-angle setting table 132, determines an object type (i.e., one of pinpoint, rectangle, application) of the visual-field-angle control, and acquires corresponding visual-field-angle information to be sent to the visual-field-angle control section 134 in accordance with the determination result.

The visual-field-angle control section 134 follows the visual-field-angle control instruction information sent from the event processing section 133, and controls the visual field angle of an object, i.e., the whole display area or a designated part of the display area of the display device 12.

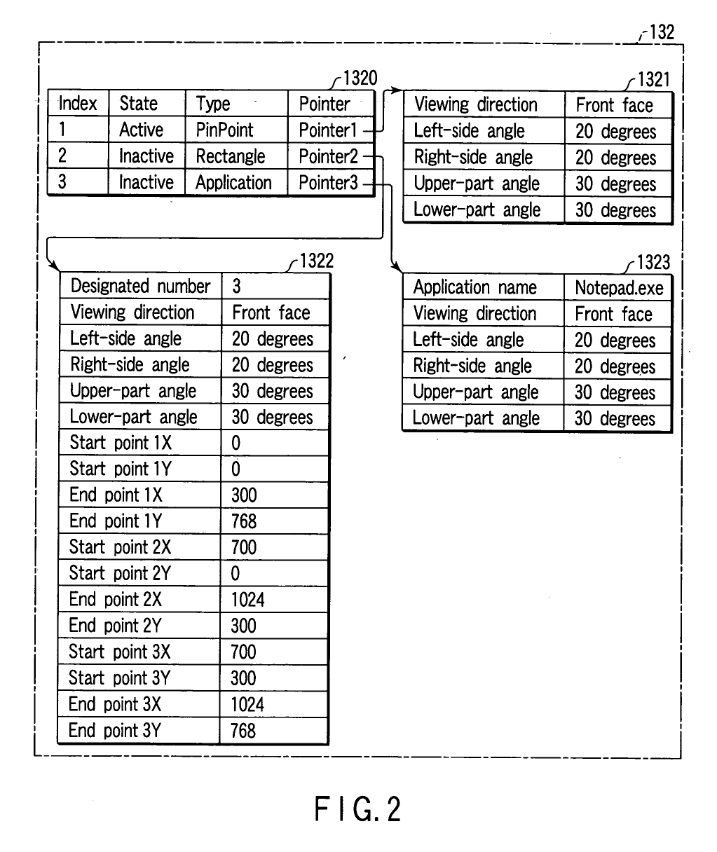

FIG. 2 is a diagram showing a configuration of a visual-field-angle setting table 132 according to the first embodiment. Here, the table 132 includes a management table 1320, and information tables 1321, 1322 and 1323 prepared for each object type (i.e., pinpoint, rectangle, application). The management table 1320 contains, for each object type, a current state (active/inactive) and a pointer that points corresponding information table. The information tables 1321, 1322 and 1323 contain visual-field-angle information with respect to a pinpoint, rectangle, and application, respectively.

One of the object types (i.e., one of the pinpoint, rectangle, and application) is brought in an active state on the management table 1320. The event processing section 133 acquires the visual-field-angle information held in one of the information tables 1321, 1322 and 1323, which is indicated by a pointer corresponding to the object type in an active state on the management table 1320 and transfers the acquired information to the visual-field-angle control section 134 as a visual-field-angle control instruction information.

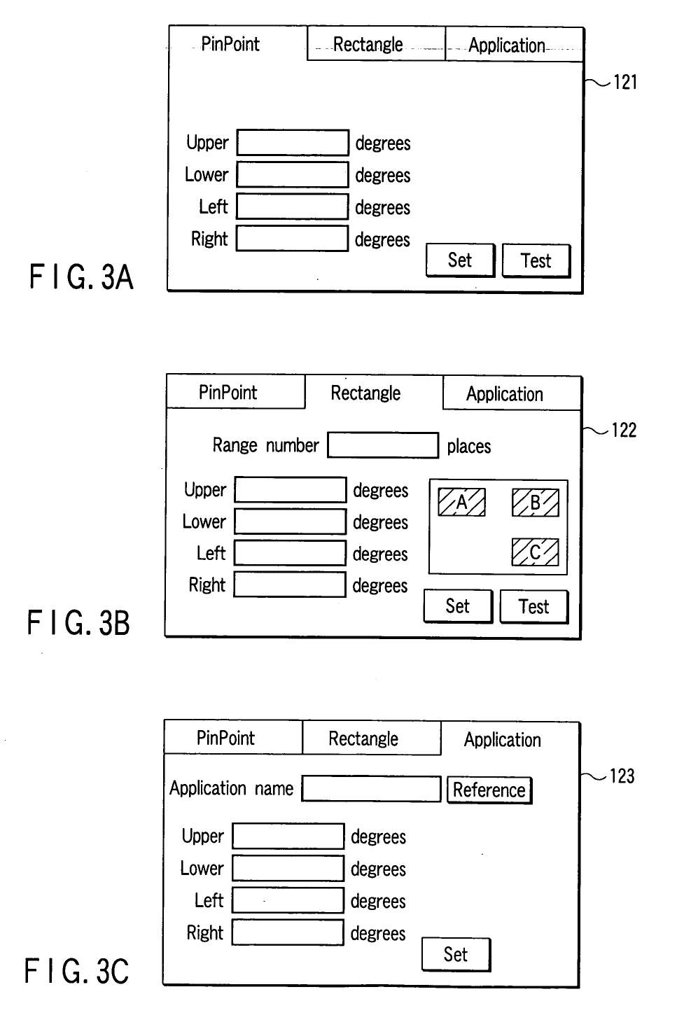

FIGS. 3A, 3B, and 3C are diagrams showing configurations of each type of visual-field-angle setting screen for use in setting the visual-field-angle information shown in FIG. 2 described above.

A pinpoint visual-field-angle setting screen 121, shown in FIG. 3A, is used to set visual field angle information with respect to the whole display area. A rectangle visual-field-angle setting screen 122, shown in FIG. 3B, is used to partially set visual field angle information only with respect to an arbitrary rectangular region as a part of the display area. An application visual-field-angle setting screen 123, shown in FIG. 3C, is used to set visual field angle information by a unit of application.

Here, a setting and control operation of the visual field angle according to the first embodiment will be described with reference to the drawings.

A user can selectively use various visual-field-angle setting screens shown in FIGS. 3A, 3B, and 3C to set the visual field angle, and can dynamically set the visual field angle with respect to an object on the display area of the display device 12 to vary the visual field angle of the object.

For example, in use of the pinpoint visual-field-angle setting screen 121 shown in FIG. 3A, a visual field angle is designated and a “test” button on the screen is pressed (clicked), the corresponding visual-field-angle control instruction information for test is sent from the event processing section 133 to the visual-field-angle control section 134, and the display area of the display device 12 is controlled to have a visual field angle which is temporarily set for test.

Moreover, when a visual field angle is designated in the pinpoint visual-field-angle setting screen 121 and a “set” button on the screen is pressed (clicked), the corresponding visual-field-angle information is set in the visual-field-angle setting table 132 and the corresponding visual-field-angle control instruction information is sent from the event processing section 133 to the visual-field-angle control section 134, and the display area of the display device 12 is controlled to have the set visual field angle. At this time, the management table 1320 of the visual-field-angle setting table 132 indicates that the pinpoint type is now in an active state.

In use of the rectangle visual-field-angle setting screen 122, when rectangular regions which are the object of the visual-field-angle control and the visual field angle of each rectangular region are designated and the “test” button on the screen is pressed (clicked), the corresponding visual-field-angle control instruction information for the test is sent from the event processing section 133 to the visual-field-angle control section 134, and the set rectangular regions on the display area of the display device 12 is controlled to have visual field angles which are temporarily set for test.

Moreover, when the rectangular regions and the visual field angle of each rectangular region are designated and the “set” button on the rectangle visual-field-angle setting screen 122 is pressed (clicked), the corresponding visual-field-angle information is set in the visual-field-angle setting table 132 and the corresponding visual-field-angle control instruction information is sent from the event processing section 133 to the visual-field-angle control section 134, and the set rectangular regions on the display area of the display device 12 is controlled to have the set visual field angles.

In use of the application visual-field-angle setting screen 123, when the application (application program) that is the object of the visual-field-angle control and the visual field angle are designated and the “set” button on the screen is pressed (clicked), the corresponding visual-field-angle information is set in the visual-field-angle setting table 132 and the corresponding visual-field-angle control instruction information is sent from the event processing section 133 to the visual-field-angle control section 134, and each screen of the designated application is controlled to have the set visual field angle at the time of execution of the designated application.

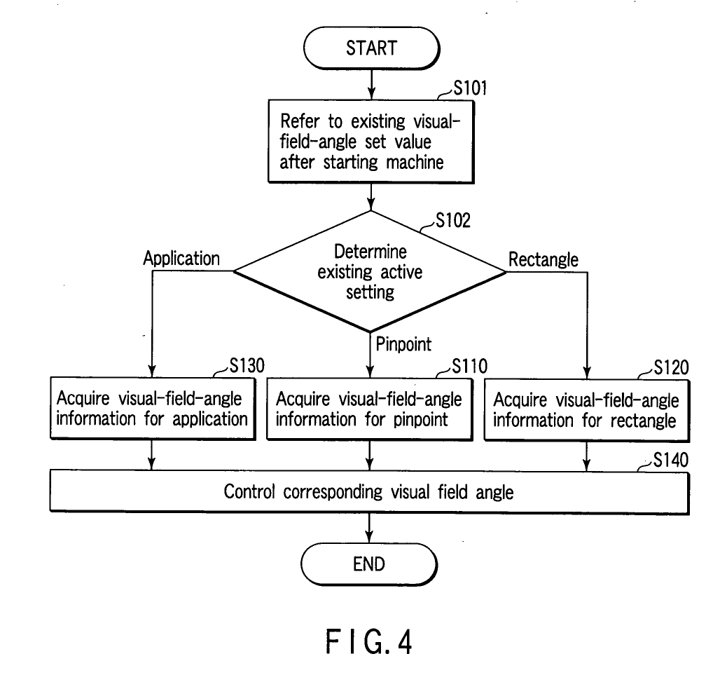

Operations of various visual-field-angle controls will be described with reference to the flowcharts shown in FIGS. 4 to 9.

When a system is started, the visual-field-angle control section 134 controls the visual field angle of an object on the display area of the display device 12 in accordance with existing visual-field-angle control instruction information by referring to the corresponding existing set values (step S101 of FIG. 4). For example, the visual-field-angle control may not be executed at the time of starting system from an initial state (In this case, broad angle display is performed); however the visual-field-angle control may be executed at the time of resuming the system in accordance with the visual-field-angle control instruction information held at the time of suspending the system.

The event processing section 133 receives various events from the main body processing device 10, setting processing section 131, and the like. Every time, the event processing section refers to the visual-field-angle setting table 132 to determine whether the existing active setting, that is, the type now in the active state is the pinpoint, rectangle, or application (step S102).

When the type now in the active state is the pinpoint (i.e., the visual field angle has been set on the pinpoint visual-field-angle setting screen 121 shown in FIG. 3A), the visual-field-angle control of the pinpoint is executed (step S110).

When the type now in the active state is the rectangle (i.e., the visual field angle has been set on the rectangle visual-field-angle setting screen 122 shown in FIG. 3B), the visual-field-angle control of the rectangle is executed (step S120).

When the event indicates an application start command from the main body processing device 10 and the type now in the active state is the application (i.e., the visual field angle has been set on the application visual-field-angle setting screen 123 shown in FIG. 3C), the visual-field-angle control of the application is executed (step S130).

In the visual-field-angle control of each type, the visual-field-angle control section 134 controls the visual field angle of the object on the display area based on the information notified from the event processing section 133 (step S140).

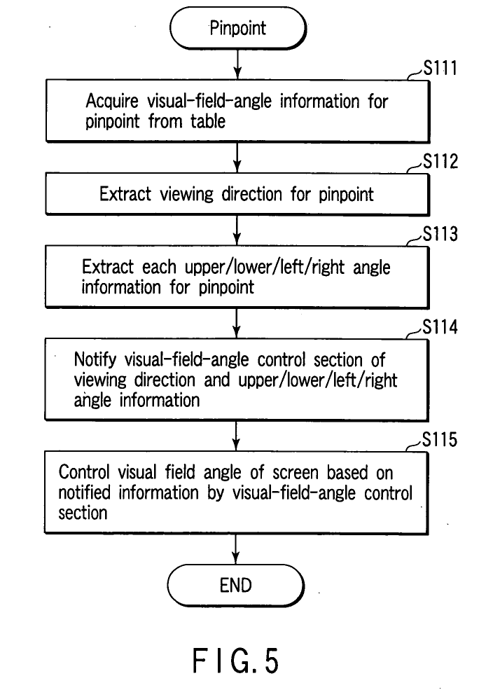

An operation of the visual-field-angle control of the pinpoint will be described with reference to the flowchart shown in FIG. 5.

In the visual-field-angle control of the pinpoint, the event processing section 133 acquires visual-field-angle information for the pinpoint from the information table 1321 in the visual-field-angle setting table 132 (step Sill). The event. processing section 133 reads out the viewing direction and upper/lower/left/right angle information (steps S112 and S113) and sends the read-out information as the visual-field-angle control instruction information to the visual-field-angle control section 134 (step S114).

On receiving the visual-field-angle control instruction information from the event processing section 133, the visual-field-angle control section 134 controls the visual field angle of the object (e.g., a screen) on the display area of display device 12 in accordance with the received control instruction information (step S115).

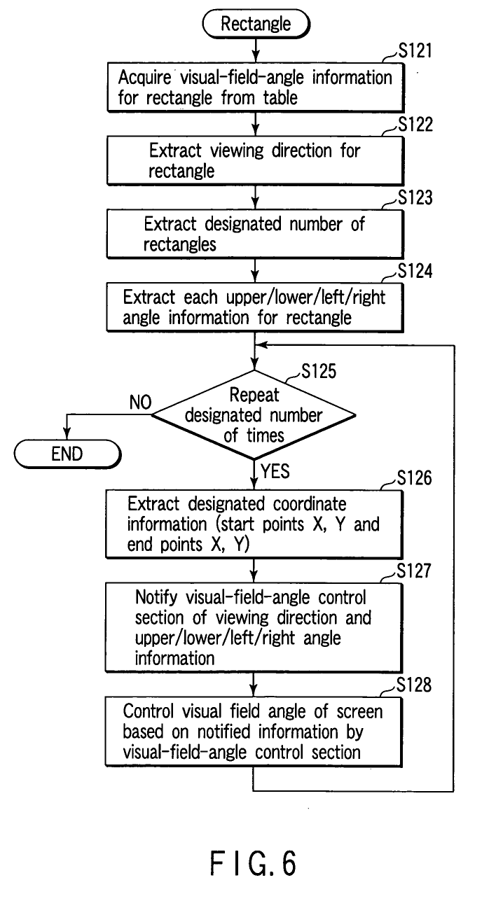

An operation of the visual-field-angle control of the rectangle will be described with reference to the flowchart shown in FIG. 6.

In the visual-field-angle control of the rectangle, the event processing section 133 acquires visual-field-angle information for the rectangle from the information table 1322 in the visual-field-angle setting table 132 (step S121). The event processing section 133 reads out the viewing direction, the number of rectangular regions, and upper/lower/left/right angle information (steps S122 to S124).

For each region, the event processing section 133 reads out coordinate information (including start points X, Y and end points X, Y) (step S126) and sends them with the viewing direction and upper/lower/left/ right angle information as the visual-field-angle control instruction information to the visual-field-angle control section 134 (step S127).

On receiving the visual-field-angle control instruction information from the event processing section 133, the visual-field-angle control section 134 controls the visual field angle of a rectangular region on the display area of the display device 12 in accordance with the received control instruction information (step S128).

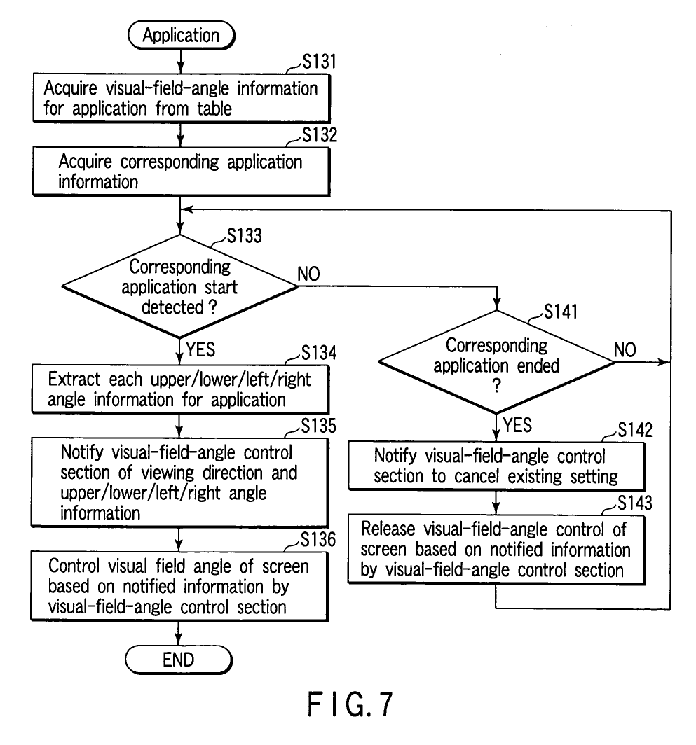

An operation of the visual-field-angle control of the application will be described with reference to the flowchart shown in FIG. 7.

In the visual-field-angle control of the application, the event processing section 133 responds to an event from the main body processing device 10 and acquires visual-field-angle information for the application (including application name, viewing direction, upper/lower/left/right angle information) from the information table 1323 in the visual-field-angle setting table 132 (step S131) and acquires related application information (step S132).

The event processing section 133 determines whether or not the event indicates a start of the application with an application name that is the same application name included in the information acquired from the table 132 (step S133). Here, when the event indicates the start of the application (YES in step S133), the event processing section 133 reads out the viewing direction and upper/lower/left/right angle information (step S134), and sends them as the visual-field-angle control instruction information to the visual-field-angle control section 134 (step S135).

On receiving the visual-field-angle control instruction information from the event processing section 133, the visual-field-angle control section 134 controls the visual field angle of a screen of the application program displayed in the display device 12 in accordance with the received control instruction information (step S136).

On the other hand, when the event from the main body processing device 10 indicates an end of the application (NO in step S133, YES in step S141), the event processing section 133 notifies the visual-field-angle control section 134 of the canceling of the existing visual-field-angle control instruction information (step S142).

On receiving the cancel notice of the visual-field-angle control instruction information from the event processing section 133, the visual-field-angle control section 134 terminates the visual-field-angle control in accordance with the cancel notice (step S143).

As described above, according to the first embodiment, various types of visual-field-angle controls can be executed in accordance with an event and corresponding one of the visual-field-angle information items in the table 132 set through various visual-field-angle setting screens shown in FIGS. 3A, 3B, and 3C.

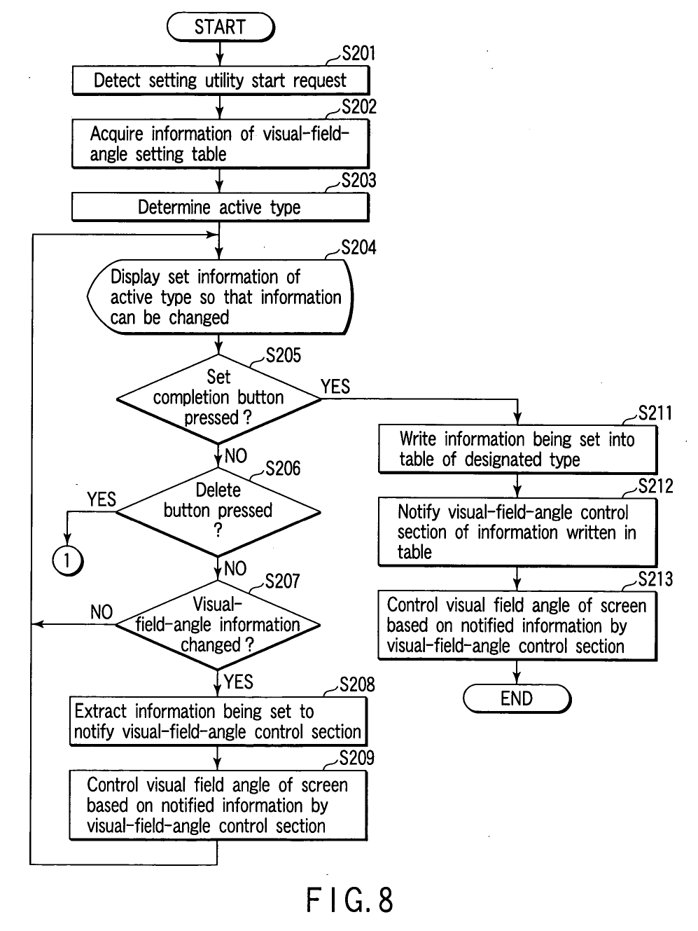

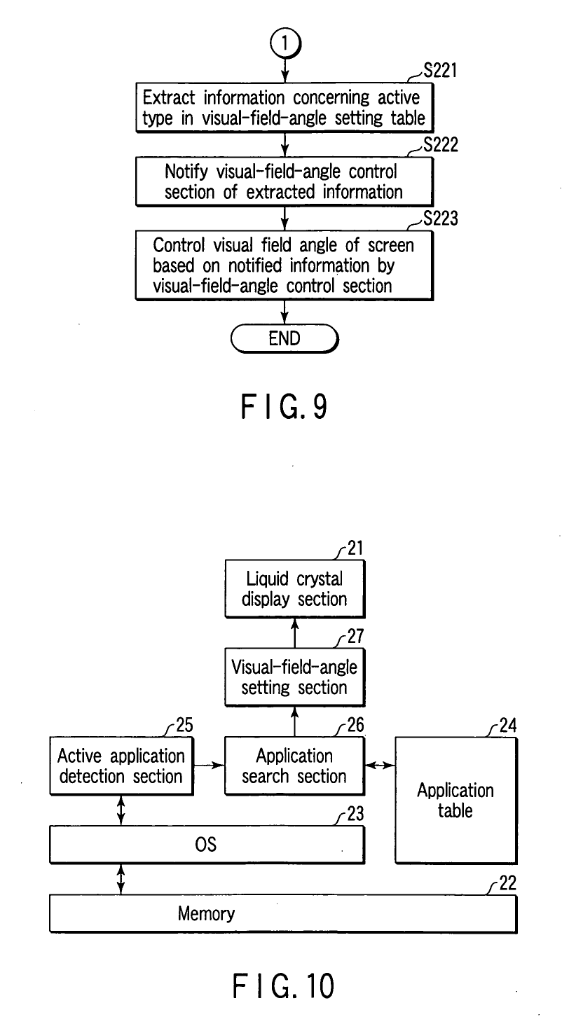

Next, the visual-field-angle control according to a second embodiment of the present invention will be described with reference to the flowcharts shown in FIGS. 8 and 9.

The second embodiment enables dynamic changes in the visual-field-angle information as set in the first embodiment. Specifically, in the second embodiment, it is possible to refer to the set visual-field-angle information items and vary (set again) them.

On receiving a start request of a setting utility with the operation of the input device 11 (step S201 of FIG. 8), the event processing section 133 acquires the visual-field-angle information from the visual-field-angle setting table 132 (step S202), determines an active type (step S203), and sends the corresponding visual-field-angle information as the changeable information to the visual-field-angle control section 134.

The visual-field-angle control section 134 displays the visual-field-angle information of the active type received from the event processing section 133 in the display device 12 as the changeable information (step S204). For example, the visual-field-angle information already set is displayed in a format shown in FIG. 3A as the changeable information.

When the visual-field-angle information is changed on the screen and a button for completion of the setting (e.g., the “set” button disposed on the screen having the format shown in FIG. 3A) is operated (YES in step S205), the corresponding visual-field-angle information of the active type in the visual-field-angle setting table 132 is changed into the visual-field-angle information newly set here (i.e., the visual-field-angle information is updated to the new visual-field-angle control information) (step S211). The event processing section 133 sends the changed visual-field-angle information to the visual-field-angle control section 134 (step S212).

On receiving the changed visual-field-angle control instruction information from the event processing section 133, the visual-field-angle control section 134 controls the visual field angle of the object (e.g., screen) on the display area of the display device 12 in accordance with the received control instruction information (step S213).

In the state where the visual-field-angle control information of the active type is displayed (step S204), when the visual-field-angle information is simply changed without any button operations (NO in step S205, NO in step S206, and YES in step S207), the changed visual-field-angle control information is sent to the visual-field-angle control section 134 (step S208).

On receiving the changed visual-field-angle control instruction information from the event processing section 133, the visual-field-angle control section 134 controls the visual field angle of the object (e.g., screen) on the display area of the display device 12 in accordance with the received control instruction information (step S209).

In a state where the visual-field-angle control information of the active type is displayed (step S204), when a delete button (e.g., “delete” button disposed on the screen having the format shown in FIG. 3A) is operated (YES in step S206), the visual-field-angle information of the active type is acquired from the visual-field-angle setting table 132 (step S221 of FIG. 9), and the corresponding visual-field-angle control information is sent to the visual-field-angle control section 134 (step S222).

On receiving the changed visual-field-angle control instruction information from the event processing section 133, the visual-field-angle control section 134 controls the visual field angle of the object on the display area of the display device 12 in accordance with the received control instruction information (step S223).

As described above, according to the second embodiment,. it is possible to dynamically change the set visual-field-angle information in which a user can refer to the set visual-field-angle information items and vary (set again) them.

Next, a third embodiment of the present invention will be described with reference to FIGS. 10 to 13.

In the third embodiment, when an application installed in the information processing apparatus becomes active, corresponding visual-field-angle information registered beforehand is automatically reflected to a screen of the active application displayed by a liquid crystal display section. Specifically, the visual field angle is automatically increased/decreased in accordance with properties of the respective applications or importance/secrecy of data to be handled, while a user does not have to consciously apply a changeover trigger. It can be anticipated that environment of high security and privacy protection is provided.

FIG. 10 is a block diagram showing a configuration of a major part of an information processing apparatus according to the third embodiment. Here, the apparatus includes a liquid crystal display section 21, memory 22, operating system (OS) 23, application table 24, active application detection section 25, application search section 26, visual-field-angle setting section 27, and the like.

The liquid crystal display section 21 has a visual-field-angle variable control function of dynamically changing the visual field angle with respect to the liquid crystal display in accordance with set values, when the visual-field-angle information is set.

In the application table 24, information items of some or all of the application programs installed in the present information processing apparatus are described together with corresponding visual-field-angle information.

The active application detection section 25 detects the application being used in a front surface of the screen (i.e., the application in an active state at present), when a plurality of application programs are simultaneously executed on the operating system (OS).

The application search section 26 searches the application table 24 for an application identical to the application detected by the active application detection section 25 to acquire the corresponding visual-field-angle information (visual-field-angle values).

The visual-field-angle setting section 27 sets the visual-field-angle information received from the application search section 26 into the liquid crystal display section 21 to change the visual field angle.

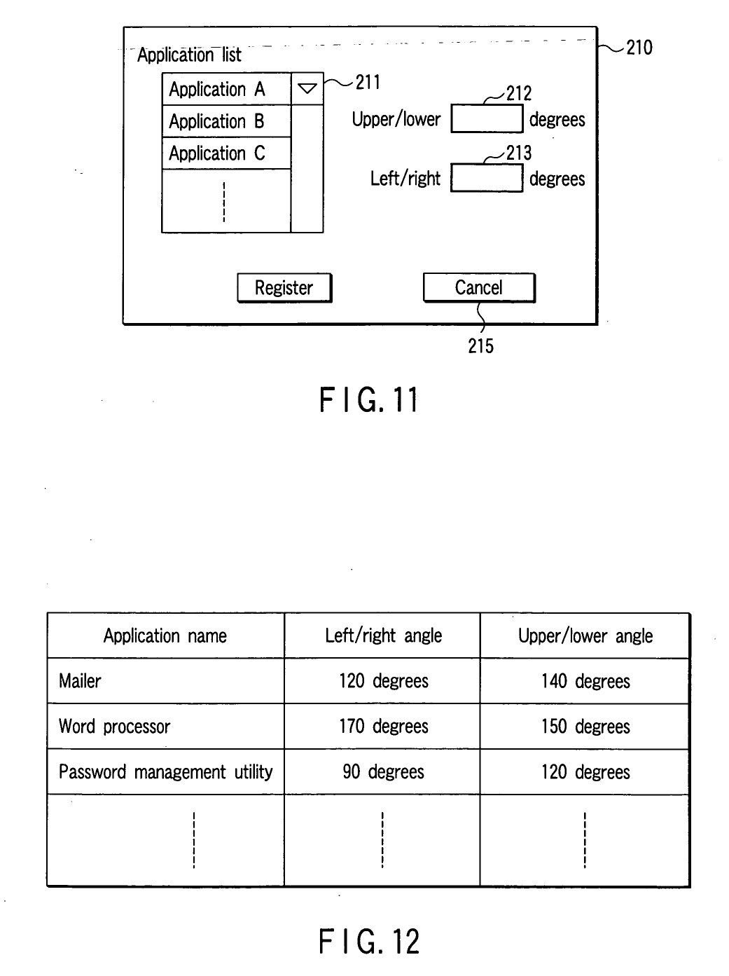

FIG. 11 is a diagram showing a configuration of a visual-field-angle setting screen 210 according to the third embodiment. Here, the screen includes an application list 211, upper/lower visual-field-angle setting field 212, left/right visual-field-angle setting field 213, “register” button 214, “cancel” button 215, and the like. In the application list 211, some or all of application programs installed in the present information processing apparatus are listed/displayed so that an application program can be selected using the application name.

FIG. 12 is a diagram showing a configuration of an application table 24 according to the third embodiment. In the table, some or all of the applications installed in the present information processing apparatus are registered together with left/right and upper/lower visual-field-angle values, when the applications are active.

For example, applications such as word processor software for usual use are registered with broad visual-field-angle values close to the limit values of the display device. Conversely, applications having high possibility of handing data high in privacy such as a mailer (application for transmitting/receiving electronic mails) are registered with relatively small visual-field-angle values. Applications in which security is regarded as important such as a password management utility are registered with a very small visual field angle. The smaller the visual field angle becomes, the more difficult it is to visually recognize the displayed information from around the display device during the use of the information processing apparatus.

The application table 24 may be a fixed table whose information cannot be edited, but it is more preferable to mount a variable table whose information can be edited and to provide a user interface for the edition. When the user can freely edit the information, a user can change the visual-field-angle values to desired values. Alternatively, the application purchased and additionally installed by a user can also be added/registered into the table. In this case, a GUI in which the user can use the visual-field-angle setting screen 210 shown in FIG. 11 is used to set and register the arbitrary visual-field-angle value. Accordingly, optimum visual field angles can be set with respect to various applications.

Moreover, “left/right angle” and “upper/lower angle” can separately be set in the application table 24 shown in FIG. 12, but a constitution other than this may also be used. For example, four upper/lower/left/right directions may individually be described, or a single value may collectively be set with respect to all the directions. Moreover, “no care” may also be described for a case in which, for example, the visual field angle is changed only in the left/right direction and any value may be set in the upper/lower direction.

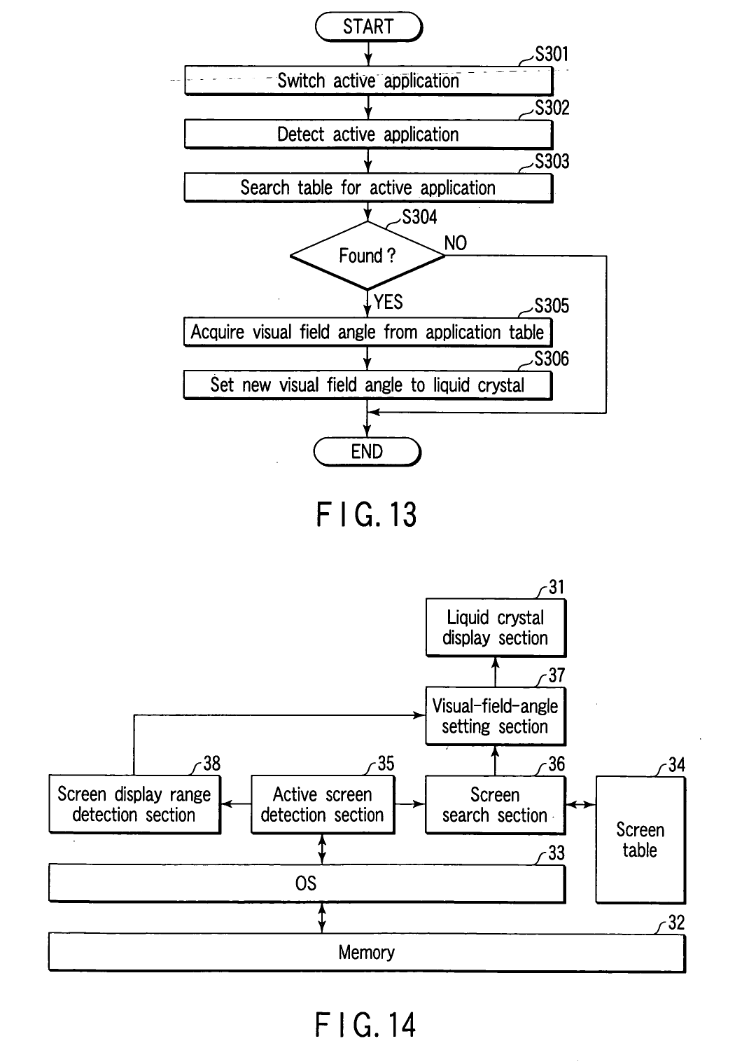

FIG. 13 is a flowchart showing a procedure of an automatic visual-field-angle change process according to the third embodiment.

The setting and control operation of the visual field angle in the third embodiment will be described hereinafter with reference to FIGS. 10 to 13.

An active application switching is executed (step S301 of FIG. 13), and an application newly become active is detected by the active application detection section 25 (step S302). The active application may be switched by a user's operation in some cases, or automatically switched by the processing of the OS in other cases. The detection processing of the active application may be executed upon a trigger using a message transmitted from the OS as a trigger, or a trigger which is periodically generated to execute the processing with polling.

The application search section 26 determines whether or not an application identical to the application newly become active is registered in the application table 24 (step S303).

When the application is not found (not registered in the application table 24) in this search processing (NO in step S304), this indicates that the visual field angle does not have to be changed in the application, and therefore the processing is ended.

On the other hand, when the application is found (YES in step S304), the corresponding visual-field-angle information is acquired from the application table 24, and sent to the visual-field-angle setting section 27 (step S305).

On receiving the visual-field-angle information from the application search section 26, the visual-field-angle setting section 27 sets a new visual field angle with respect to the liquid crystal display section 21 in accordance with the received visual-field-angle information (step S306).

In this manner, the visual field angle of the screen of the active application displayed by the liquid crystal display section 21 is automatically changed to the visual field angle fit for properties of the active application.

In the above-described third embodiment, the change control of the visual field angle is executed with respect to the active “application” as the object, but it is also possible to execute the change control of the visual field angle with respect to an active “screen” as the object. Here, the “screen” indicates a “window” or “dialog” managed by an OS providing a graphical user interface.

When there are a plurality of applications which use the common screen (e.g., dialog), the screen information and corresponding visual-field-angle information items fit for properties of the screen may be registered in the table, and the registered information is used in changing the visual field angle. For example, when a “password input dialog” for allowing the user to input a password character string is active, it is preferable to decrease the visual field angle of the screen on a liquid crystal display section.

Next, a fourth embodiment of the present invention will be described with reference to FIG. 14. In the fourth embodiment, the liquid crystal display section can not only change the visual field angle of the whole display area but also the visual field angle of a display range of a certain screen (i.e., a part of the display area).

FIG. 14 is a block diagram showing a major part of a configuration of an information processing apparatus according to the fourth embodiment. Here, the constitution includes a liquid crystal display section 31, memory 32, operating system (OS) 33, screen table 34, active screen detection section 35, screen search section 36, visual-field-angle setting section 37, screen display range detection section 38, and the like.

The liquid crystal display section 31 has a visual-field-angle variable control function of dynamically changing the visual field angle of an active screen in accordance with the set value, when the visual field angle is set. In the screen table 34, visual-field-angle information for screens as display objects is registered.

The screen display range detection section 38 acquires information of a display range (including coordinate, size, and the like) of an active screen detected by the active screen detection section 35, and notifies the visual-field-angle setting section 37 of the information.

The visual-field-angle setting section 37 sets the visual-field-angle information notified from the screen search section 36 only with respect to the range notified from the screen display range detection section 38 in the liquid crystal display section 31.

As described above, according to the fourth embodiment, since an appropriate visual field angle can be registered for each screen, it is possible to appropriately change the visual field angle only with respect to the display range of an active screen when the active screen is displayed.

As described above in detail, according to the present invention, a user can arbitrarily set visual field angles of objects on a display area.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus, comprising:
a display device;
a setting processing section capable of setting information related to a visual field angle of an object on a display area of the display device; and
a control section configured to control the visual field angle of the object on the display area in accordance with the information set by the setting. processing section.

2. The information processing apparatus according to claim 1, wherein the setting processing section is capable of setting information related to a visual field angle of a rectangular region as a part of the display area.

3. The information processing apparatus according to claim 1, wherein the setting processing section is capable of setting information related to a visual field angle of a screen of an application program to be displayed on the display area.

4. The information processing apparatus according to claim 1, wherein the control section changes the visual field angle of the object on the display area in accordance with change of the information set by the setting processing section.

5. The information processing apparatus according to claim 1, wherein the setting processing section is capable of setting information related to a visual field angle of an active screen or a screen of an active application program to be displayed on the display area.

6. The information processing apparatus according to claim 1, wherein the setting processing section sets the information in accordance with designation on a predetermined setting screen.

7. The information processing apparatus according to claim 1, wherein the setting processing section is capable of setting information related to a visual field angle of the display area.

8. The information processing apparatus according to claim 1, wherein the setting processing section is capable of setting one of information related to a visual field angle of the display area and information related to a visual field angle of a part of the display area.

9. An information processing apparatus, comprising:
a display device;
a setting processing section capable of setting information related to a visual field angle of an object on a display area of the display device;
a storage section storing the information set by the setting processing section;
an event processing section configured to output a control instruction information corresponding to part of the information stored in the storage section in response to an event; and
a control section configured to control the visual field angle of the object on the display area in accordance with the control instruction information output by the event processing section.

10. The information processing apparatus according to claim 9, wherein the event processing section outputs the control instruction information in response to one of an event setting by the event processing section and an event indicating a start request.

11. The information processing apparatus according to claim 9, wherein the storage section stores a table including a plurality of information items on which a plurality of visual field angles are designated for a plurality of objects on the display area.

12. The information processing apparatus according to claim 11, wherein the table further includes information indicating an active object whose visual field angle is to be controlled on the display area.

13. The information processing apparatus according to claim 9, wherein the storage section stores a table including a plurality of information items on which a plurality of visual field angles are designated for a plurality of application programs to be displayed on the display area.

14. The information processing apparatus according to claim 9, wherein the setting processing section is capable of setting information related to a plurality of visual field angles for a plurality of application programs to be displayed on the display area.

15. The information processing apparatus according to claim 9, wherein the setting processing section is capable of setting information related to a plurality of visual field angles for a plurality of screens to be displayed on the display area.

16. A display control method applied to an information processing apparatus having a display device, the method comprising:
enabling a setting of information related to a visual field angle of an object on a display area of the display device; and
controlling the visual field angle of the object on the display area in accordance with the information set in the setting.

17. The method according to claim 16, wherein the enabling the setting includes enabling a setting of information related to a visual field angle of a rectangular region as a part of the display area.

18. The method according to claim 16, wherein the enabling the setting includes enabling a setting of information related to a visual field angle of a screen of an application program to be displayed on the display area.

19. The method according to claim 16, further comprising changing the visual field angle of the object on the display area in accordance with change of the information set in the setting.

20. The method according to claim 16, wherein the enabling the setting includes setting the information in accordance with designation on a predetermined setting screen.
